(19) United States
(12) Patent Application Publication
(10) Pub. No.: US 2021/0097568 A1
(43) Pub. Date: Apr. 1, 2021

(54) DELEGATED GIFT MARKETING SYSTEM AND METHOD

(71) Applicant: David Bagley, MInneapolis, MN (US)

(72) Inventor: David Bagley, MInneapolis, MN (US)

(21) Appl. No.: 17/034,592

(22) Filed: Sep. 28, 2020

Related U.S. Application Data
(60) Provisional application No. 62/906,503, filed on Sep. 26, 2019.

(51) Int. Cl. G06Q 30/02; G06Q 50/00; G06F 16/955

(52) U.S. Cl. CPC G06Q 30/0246; G06Q 30/0276; G06F 16/9558; G06Q 30/0279; G06Q 50/01

(57) ABSTRACT

A method includes creating an advertisement in a gift provisioning system, providing a link to the advertisement in the gift provisioning system, and allocating an initial gift value amount to be associated with the advertisement. The advertiser sends a link to the advertisement to a plurality of advertisement recipients, and provides a prompt list of receiving organizations to which advertisement recipients can direct gift values. An apparatus is also disclosed which carries out the method.

### FIELD OF THE INVENTION

The present disclosure relates to a method for a delegated gift marketing system, and a method for delegating gifting and marketing.

### BACKGROUND OF THE INVENTION

Successful businesses are generally called upon to make gifts to charity or the like. Many businesses even advertise the institutions to which they give money in hopes building good feelings and building good will with current customers as well as potential customers. The businesses that decide to make gifts generally make a decision on charities at an executive level. Other companies devise ways for employees to direct where to send charitable dollars. Generally, a pot of money is designated for charitable giving and all or a portion of the money can be voted on by employees. In some instances, the voting takes the form of volunteer hours. Employees may volunteer for one of many organizations. For example, an employee might be a volunteer for the Boy Scouts of America. Another employee might volunteer for Habitat for Humanity. All the volunteer hours are then put into the pot and a percentage of the total volunteer hours is calculated for each organization. The percentage is then applied to the pot of gift money that the company has designated. The money is then distributed from the company based on the percentages determined. This is one example of the employees voting on the distribution of the funds provided by a company.

There are several problems with most prior schemes to create good will. Among the problems is that the customer may not really approve of the charities selected by a company. In other instances, the customer may be indifferent with respect to the charities selected. In both of these instances, giving to charity with the idea of building good will is not as effective at building good will as it could be. In fact, giving to charity with the idea of building good will might not have any effect at all unless a company happens to give to a charity that just happens to correspond to the interests of a customer. In other instances, the charity or organization selected by a company may upset the potential customer.

### SUMMARY

A method of gifting allows customers of a company to direct gift funds toward charities or other organizations by delegating that authority and action to individuals with whom they wish to develop a relationship. A gift provisioning system provides a structure for carrying out the above method. A network of gift receiving organizations is established as part of the gift provisioning system. The network of organizations are institutions that can receive gift money. The gift provisioning systems allows for adding gift receiving organizations. A company or organization, in some embodiments, creates an advertising campaign in which companies provide gift funds to the customer to distribute between a selected set of recipient organizations. The advertising organization will select a set of recipient organizations that best align with the brand values or the advertising organization or a particular campaign. The created advertisement is then shared through the advertising company's social media channels, such as Facebook, email, and the like. The advertiser also links the ad to the gift provisioning system. Part of the value of advertisement is the advertising company giving the target of the ad an amount of gift funds to direct to an organization of their choosing and actively engaging them in that action, thus creating a different level of ownership and engagement. The recipient organization is selected from the network of organizations. As mentioned, organizations can be added to the network for future advertising campaigns. The target customer can add funds to the amount provided.

If the recipient of the created advertisement has a favorite organization that is not within the gift fund network, they can suggest or ask that the potential recipient join the gift fund network so that they too can receive funds. The gift fund provisioning system measures the effectiveness of an ad campaign where the customer gets to redistribute the funds, and allows tracking of the gift funds for the gift originating company. The gift fund provisioning system can track metrics and also keep various records. Reports can also be generated out of the gift fund provisioning system.

Additional advantages and features of the invention will be set forth in part in the description which follows, and in part will become apparent to those skilled in the art upon examination of the following or may be learned by practice of the invention.

### BRIEF DESCRIPTION OF THE DRAWINGS

FIG. 1 is a Delegated Gift Marketing System for distributing funds as part of an advertising campaign, according to an example embodiment.

FIG. 2 a flow chart of a method for distributing funds as part of an advertising campaign, according to an example embodiment .

FIG. 3 is screen shot associated with the creating the advertisement element of the method for distributing funds, according to an example embodiment.

FIG. 4 is screen shot associated with the Share a link to the ad campaign element of the method for distributing funds, according to an example embodiment.

FIG. 5 is screen shot associated with the Prompt customers to accept the ad campaign element of the method for distributing funds, according to an example embodiment.

FIG. 6 is screen shot associated with the receive inputs regarding allocation of gift value element of the method for distributing funds, according to an example embodiment.

FIG. 7 is screen shot associated with the Add to gift value element of the method for distributing funds, according to an example embodiment.

FIG. 8 is screen shot associated with the Allocation of funds to recipient organizations, and the Report Transaction element of the method for distributing funds, according to an example embodiment.

FIG. 9 is screen shot associated with the Review and Report the results of the ad campaign_element of the method for distributing funds, according to an example embodiment.

FIG. 10 shows a diagrammatic representation of a computing device for a machine in the example electronic form of a computer system 2000, according to an example embodiment.

FIG. 11 is a diagrammatic representation of a computing device for another embodiment of a Delegated Gift Marketing System for distributing funds as part of an advertising campaign is in the form of a number of modules that interact with a processor, memory and display.

### DETAILED DESCRIPTION

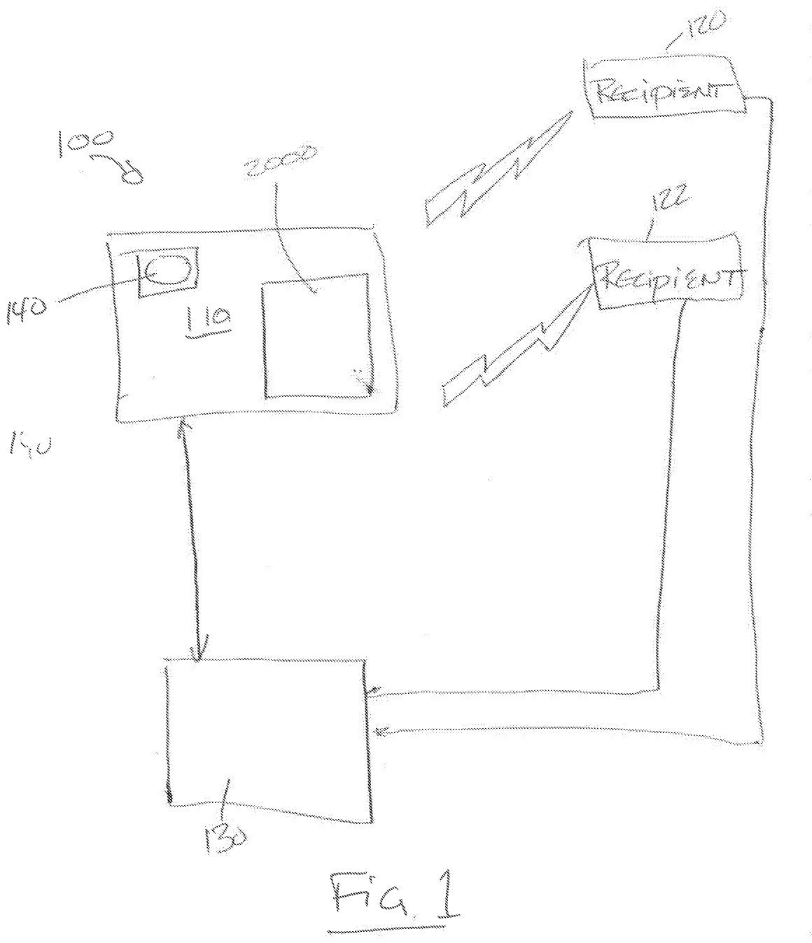

FIG. 1 is a Delegated Gift Marketing System 100 for distributing funds as part of an advertising campaign, according to an example embodiment. The Delegated Gift Marketing System 100 includes a gift provisioning system 110 for creating advertisements includes a computing machine or computer system 2000 that communicates advertisements or advertising campaigns to recipients 120 and 122. The gift provisioning system 110 lists one or more entities for receiving gifts in memory in the form of a database 130. A display or user interface 140 is used to present prompts and to receive inputs to said prompts. Other input devices, for example a keyboard, can be used for receiving inputs. An advertisement includes a gift value that is given to at least one recipient. The recipient of an ad campaign can designate ore or more of the entities on the list for receiving funds provided to the recipients of the ad campaign. The recipients of the funds can also be thought of as designating the payments provided to them to one of the entities on the listing kept by the gift provisioning system. The recipients can also request that certain entities be added to the list. The system can be described at a high level as a closed loop system for consumer driven advertising that combines delegated gift giving and micro-payments.

The delegation of the gift value by the advertiser to the customer, allows the advertiser to build a brand and also build a relationship through customer/prospect/team member empowerment and delegated trust.

This system enables a person to design a campaign—identifying the potential charities or organizations that are eligible receivers of the funds, offering those funds to a list of individuals for delegated distribution, and then enjoying the relationship benefits of this action in reflected gratitude—the gift of giving. This method of delegating a value to a customer for the customer to give will be described in the following paragraph as well as several systems used for gift giving.

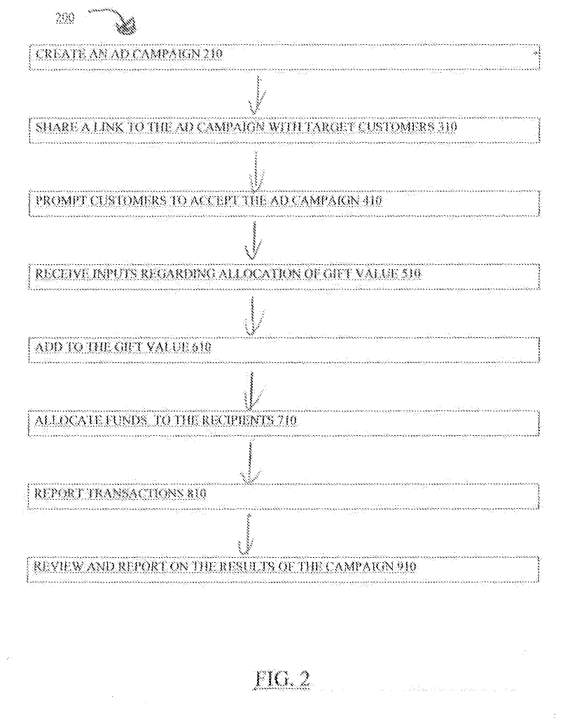

Now referring to the FIG. 2, the method 200 used for Delegated Gift Marketing and the gift provisioning system will be further detailed. FIG. 2 is a flow chart of the method 200 for distributing funds as part of an advertising campaign, according to an example embodiment. The method 200 includes creating an ad campaign 210, sharing a link to the ad campaign with target customers 310, prompting customers to accept the ad campaign 410, receiving inputs regarding allocation of gift value 510, add to the gift value 610, allocate funds 710 to the recipients, report transactions 810, and review and report on the results of the campaign 910.

FIG. 3 is screen shot 300 associated with the creating the advertisement element 210 of the method 200 for distributing funds 200, according to an example embodiment. Creating an ad campaign in the system includes inputting a campaign title 320, and adding images 322 such as a logo and the like. Other images may also be input. There are blanks on the screen for these inputs. The blanks serve as prompts for the various inputs. There is an additional area on the screen for input of the ad copy or the promotional pitch for the advertisement 324. Creating the ad campaign also includes an input for the amount of gift value that is to be given to each customer 326, setting a time frame for the ad campaign 328, and setting forth at least one organization eligible to receive portions of gifts allocated to the various customers 330. The timeframe set is basically a start and a stop date for the ad campaign. It could be set with specific dates or could be done on the basis of a rule. For example, an advertisement can be set to run for a time period after a triggering event.

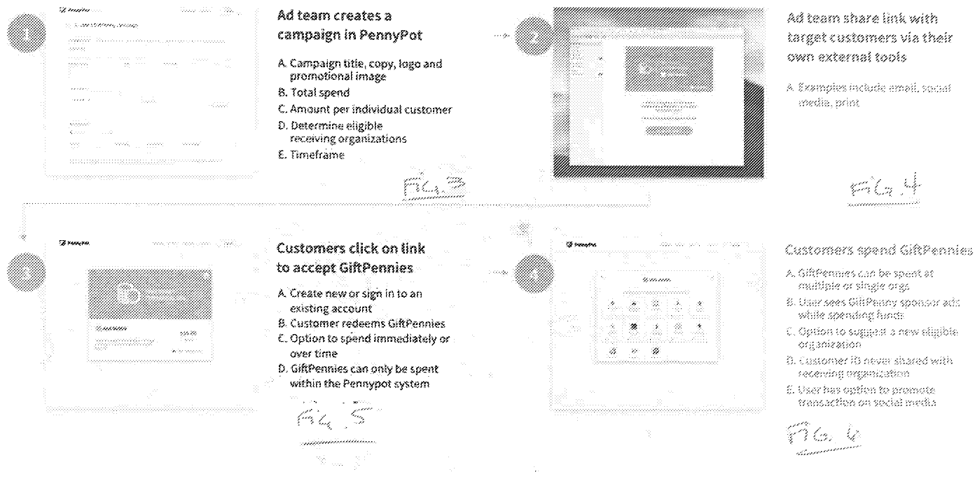

FIG. 4 is screen shot associated with the Share a link to the ad campaign element 310 of the method 200 for distributing funds, according to an example embodiment. FIG. 4 shows a screen shot 400 that includes a prompt to share a link to the advertisement. In one embodiment, the screen shot 400 will include a prompt for the advertiser to list one or more social media accounts. In some embodiments of the invention, the advertiser may have previously saved various media accounts and the prompt can include a listing of media accounts. The prompt would include an invitation to check the media accounts which should be used as channels for distribution of the ad campaign. All options are available including adding additional social media accounts to a list or a prompt not to keep track of media accounts of the business running the ad campaign.

FIG. 5 is screen shot associated with the Prompt customers to accept the ad campaign element 410 of the method 200 for distributing funds, according to an example embodiment. The customer is provided with a prompt 500 to accept the gift value. In one embodiment, the customer is prompted to create a new account in the gift provisioning system. If the customer has an account, this prompt can be skipped or the prompt can be included with an alternative log in screen. Prompts for redeeming all the gift value at once or over time can be selected. The potential recipients of gift value are listed as at least one prompt for distributing the gift value. In one example, a number of approved charities that can receive the gift value are listed. Of course, organizations other than charities In another embodiment, the gift value recipients are approved by the system or by the advertisers.

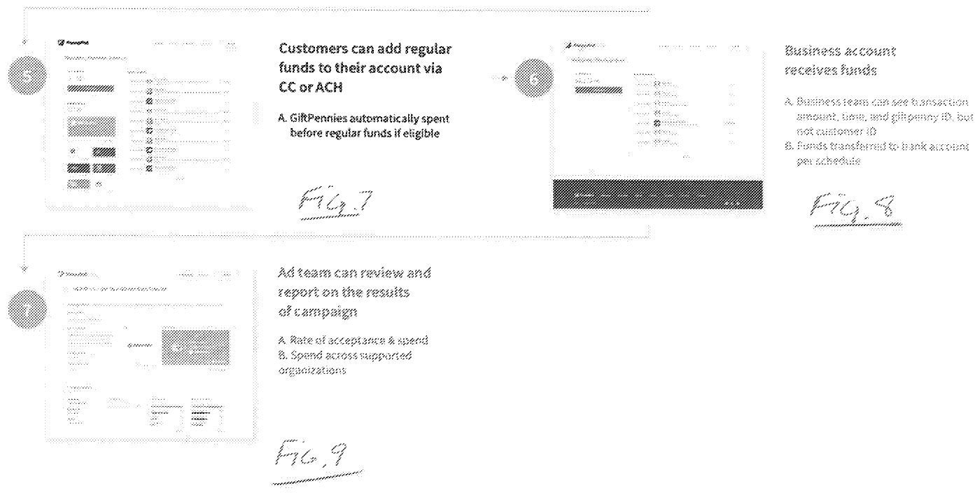

FIG. 6 is screen shot associated with the receive inputs regarding allocation of gift value element of the method 200 for distributing funds, according to an example embodiment. Inputs are received as to which organizations are to receive the gift value, as well as at what time the gift value is to be presented. In some embodiments, an option is provided to suggest new organizations for receipt of gift value. In this way, the customer, if they have a favorite organization that a customer would like to give at least a portion of their gift value to, this favorite organization can be approved for the particular customer. In another embodiment, a new organization can be approved and listed with the other approved organizations so any customer can give to the new organization. The customer is also given the option to promote the transaction via their social media. In effect, the customer is able to do good will advertising on their behalf as an add on to the goodwill advertising done by the initial advertiser. Put another way, the customer is able to piggy back off of the original advertising and the action of directing money to various organizations, such as charities. In one embodiment, ads can be presented over the system by sponsors of the original system and sponsors of the original ad as the customer is presented with prompts and responding to those prompts.

FIG. 7 is screen shot associated with the Add to gift value element 610 of the method 200 for distributing funds, according to an example embodiment. The customer or party to which an add is sent has the option to add to the gift value through the system 100. The advertiser provides gift value for the customer to distribute to various organizations associated with the system 100. A screen 700 is presented to the customer that includes a prompt 720 for the option to add additional value to the amount initially provided by the advertiser. There are also prompts for how the additional value is to be given. For example, one option is to give the initial amount provided first and the amount added last. Other orders and rules can be provided. A screen could also be provided to allow the customer to prepare customized rules for the distribution of the additional gift value amount. Of course, the additional gift value amount could be distributed along with the initial amount.

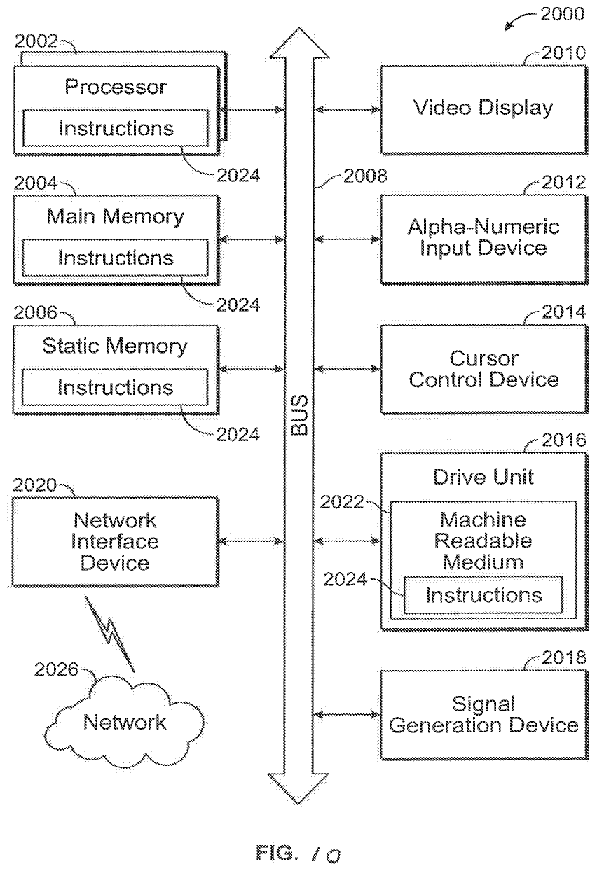

Once inputs have been received regarding the allocation of funds, the funds are allocated to the various organizations per the inputs received by the system. In other words, the prompts of FIGS. 6 and 7 result in inputs on which the system 10 acts. FIG. 8 is screen shot 800 associated with the Allocation of funds to recipient organizations 710 and the Report Transaction element 810 of the method 200 for distributing funds, according to an example embodiment. The screen 800 is shown includes transaction amounts and times of the transactions for the gift values. The screen 800 also shows the amount of funds transferred to to organizations that receive the gift value. The system, therefore, keeps a record of the transactions and times for the funds. Certain numbers and IDs can be hidden for privacy or security concerns.

FIG. 9 is screen shot associated with the Review and Report the results of the ad campaign 910 element of the method 200 for distributing funds, according to an example embodiment. There can be a number of reports that can be generated from various measures or metrics associated with the ad campaign. In various embodiments, the total amount of revenue generated, total spend, rate of acceptance and spend, and spend across supported organizations can be reported to the advertiser. Of course other reports can be generalted and sent to customers so that customers can see how various receiving organizations made out. The reports generated can be numerous. Many variations are contemplated.

Generally, there are a plurality of recipients although it is contemplated that there may be instances where there is only one recipient for a particular ad campaign. The recipients can be connected to the gift provisioning system 110 via a network connection, such as a wide area network or the internet. further including a processor and a memory associated with the processor, and a display having a graphical user interface. The display is communicatively coupled to the processor and memory. The computing machine also includes an advertising creation module including instructions that, when executed by the processor, causes the computing machine to create an advertising campaign. The instructions and processor create an advertisement in a gift provisioning system, provide a link to the advertisement in the gift provisioning system, allocate an initial gift value amount to be associated with the advertisement, and send a link to the advertisement to a plurality of advertisement recipients. The instructions and processor present a prompt at the display that lists receiving organizations to which advertisement recipients can direct or delegate gift values. The processor and instructions also receive an input that designates at least one receiving organization to receive a portion of the gift value amount. In some embodiments, more than one gift receiving organization can be designated for receiving portions of the allocated amount. In other embodiments, there also may be prompts for allocating the gift value amount among a plurality of gift receiving organizations. In still further embodiments of the gift provisioning system, the instructions of the advertising creation module further prompt gift recipients to add to the initial gift value. Sending the link to advertisement to recipients includes sending the link using a social media account, and in some cases using an advertiser's social media account. In further embodiments of the invention, the advertising creation module further includes a prompt for selecting at least one metric to measure the effectiveness of a particular advertising campaign. The metric is measured and compared to other advertising campaigns. The metric is usually for a length of time associated with the advertising campaign. The metric can be overall sales over the selected time, or can be sales per customer or an average sales per customer for all customers. Of course, it is contemplated that there can be other metrics used to measure the sales associated with an advertising campaign. It is further contemplated that a polarity of metrics can be used to measure the effectiveness of a particular ad campaign.

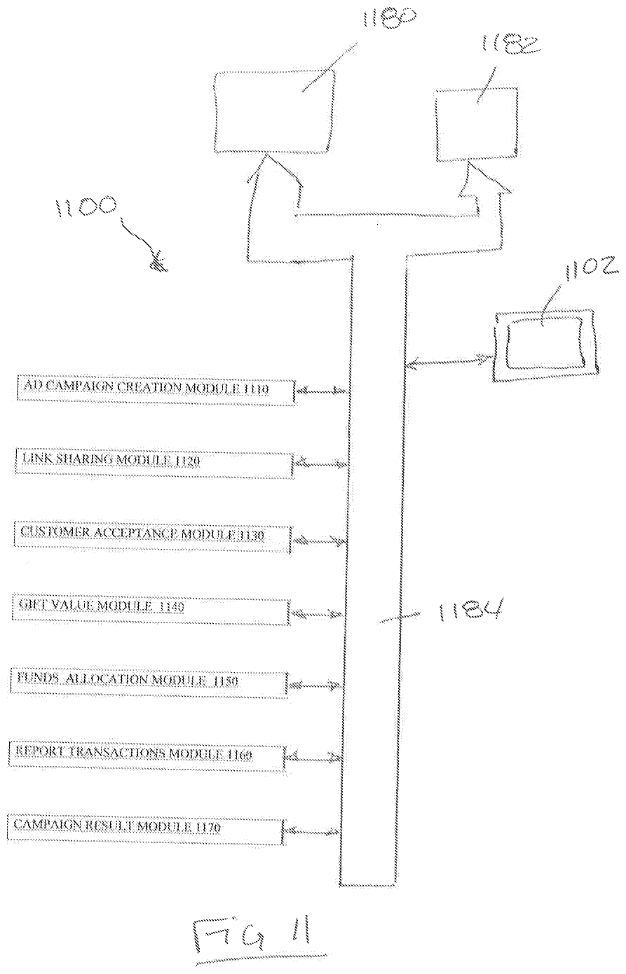

As mentioned above, the computer or processor 2000 and associated memory can be used to control many of the processes associated with the elements of the method 200 used for Delegated Gift Marketing. FIG. 10 shows a diagrammatic representation of a computing device for a machine in the example electronic form of a computer system 2000, according to an example embodiment. In various example embodiments, the machine operates as a standalone device or can be connected (e.g., networked) to other machines. In a networked deployment, the machine can operate in the capacity of a server or a client machine in a server-client network environment, or as a peer machine in a peer-to-peer (or distributed) network environment. The machine can be a personal computer (PC), a tablet PC, a set-top box (STB), a Personal Digital Assistant (PDA), a cellular telephone, a portable music player (e.g., a portable hard drive audio device such as a Moving Picture Experts Group Audio Layer 3 (MP3) player, a web appliance, a network router, a switch, a bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 2000 includes a processor or multiple processors 2002 (e.g., a central processing unit (CPU), a graphics processing unit (GPU), arithmetic logic unit or all), and a main memory 2004 and a static memory 2006, which communicate with each other via a bus 2008. The computer system 2000 can further include a video display unit 2010 (e.g., a liquid crystal display (LCD) or a cathode ray tube (CRT)). The computer system 2000 also includes an alphanumeric input device 2012 (e.g., a keyboard), a cursor control device 2014 (e.g., a mouse), a disk drive unit 2016, a signal generation device 2018 (e.g., a speaker) and a network interface device 2020.

The disk drive unit 2016 includes a computer-readable medium 2022 on which is stored one or more sets of instructions and data structures (e.g., instructions 2024) embodying or utilized by any one or more of the methodologies or functions described herein. The instructions 2024 can also reside, completely or at least partially, within the main memory 2004 and/or within the processors 2002 during execution thereof by the computer system 2000. The main memory 2004 and the processors 2002 also constitute machine-readable media. In some embodiments the disk drive includes solid state memory in combination with the disk drive. In still further embodiments, solid state memory is used instead of a disk drive unit.

The instructions 2024 can further be transmitted or received over a network 2026 via the network interface device 2020 utilizing any one of a number of well-known transfer protocols (e.g., Hyper Text Transfer Protocol (HTTP), CAN, Serial, or Modbus).

While the computer-readable medium 2022 is shown in an example embodiment to be a single medium, the term “computer-readable medium” should be taken to include a single medium or multiple media (e.g., a centralized or distributed database, and/or associated caches and servers) that store the one or more sets of instructions and provide the instructions in a computer readable form. The term “computer-readable medium” shall also be taken to include any medium that is capable of storing, encoding, or carrying a set of instructions for execution by the machine and that causes the machine to perform any one or more of the methodologies of the present application, or that is capable of storing, encoding, or carrying data structures utilized by or associated with such a set of instructions. The term “computer-readable medium” shall accordingly be taken to include, but not be limited to, solid-state memories, optical and magnetic media, tangible forms and signals that can be read or sensed by a computer. Such media can also include, without limitation, hard disks, floppy disks, flash memory cards, digital video disks, random access memory (RAMs), read only memory (ROMs), and the like.

A computer that executes a set of instructions is transformed into a specialized machine having a specific functional purpose.

It should be noted that the examples set forth above all deal with the sampling and processing of dried blood to test for various and assorted diseases and other maladies. It should be understood that the testing system could be used to collect and analyze other fluids or other bodily fluids for collection of samples and analysis of the same.

The embodiments were chosen and described in order to best explain the principles of the invention and its practical applications, to thereby enable others skilled in the art to best utilize the invention and various embodiments with various modifications as are suited to the particular use contemplated. It is intended that the scope of the invention be defined by the following claims and their equivalents.

In another embodiment, the Delegated Gift Marketing System 1100 for distributing funds as part of an advertising campaign is in the form of a number of modules 1110, 1120, 1130, 1140, 1150, 1160, and 1170. The modules 1110, 1120, 1130, 1140, 1150, 1160, and 1170 can be purely instruction sets, purely hardware, or a combination of hardware and software. The modules 1110, 1120, 1130, 1140, 1150, 1160, and 1170, are communicatively coupled to one another and to a memory 1182 and a processor 1180, and a display 1102, in one embodiment. The modules 1110, 1120, 1130, 1140, 1150, 1160, and 1170, and the memory 1182 and the processor 1180 are communicatively coupled over a bus 1184 In another embodiment, one or more modules 1110, 1120, 1130, 1140, 1150, 1160, and 1170, contain a processor and memory so that the module is dedicated and can use the processor and memory within the modulce to accormplish the tasks requeisted by the overall system 1100. In other embodiments, the module can be a portion of a larger memory and a portin of a processor. Of course, there are systems in which all modules are dedicated to a task and others where they are allocated portions of processors and portions of memory. In essence, a module could be a dedicated processor for accomplishing a process. Other modules could be controlling part of another processor, such as processor 1180 and another portion of memory, such as memory 1182.

The Ad Campaign Creation Module 1110 includes hardware or software or both hardware and software for creating an ad campaign. The Ad campaign creation module 1110 includes hardware or software or both hardware and software for producing prompts and receiving inputs to set the parameters for the advertisement. The Ad campaign module 1110 also accepts copy and images to be used in the creative display. The information received is then used to create an advertisement per the parameters set by the advertiser.

The Link Sharing Module 1120 includes hardware or software or both hardware and software for sharing a link to the ad campaign. The Link sharing module 1120 includes hardware or software or both hardware and software for producing prompts and receiving inputs regarding various channels on which to place or send the link to potential customers. The places can include various social media sites as well as email sites and other sites. Other channels may also be listed. The channels to use are selected at a display prompt. These inputs are used to send links to the ad to various customers and potential customers.

The Customer Acceptance Module 1130 includes hardware or software or both hardware and software for creating an ad campaign. The Customer Acceptance Module 1130 implements the elements for creating an advertisement of the related method. Prompts are produced for new account set ups for new customers. The customers determine where the gift value will be sent or spent. The details of how the gift value will be distributed are obtained via prompts at a user interface or display.

The Gift Value Module 1140 includes hardware or software or both hardware and software for creating an ad campaign. The Gift Value Module 1140 includes hardware or software or both hardware and software for adding to the gift value initially provided.

The Funds Allocation Module 1150 includes hardware or software or both hardware and software for allocation of the gift value to various organizations. This module distributes the gift value per the instructions set up by the customers.

The Report Transactions Module 1160 includes hardware or software or both hardware and software for creating an ad campaign. The Report Transactions Module 1160 includes hardware or software or both hardware and software for tracking transactions related to distribution of gift value amounts.

The module also tracks when additions are made to the gift value. The Campaign Result Module 1170 includes hardware or software or both hardware and software for creating an ad campaign. The Campaign Result Module 1170 includes hardware or software or both hardware and software for creating an ad campaign. The Campaign Result Module 1170 includes hardware or software or both hardware and software used to generate reports based on parameters selected The reports, in one embodiment, measure the effectiveness of the ad campaign.

In summary, disclosed is a method that includes creating an advertisement in a gift provisioning system, providing a link to the advertisement in the gift provisioning system, and allocating an initial gift value amount to be associated with the advertisement. The advertiser sends a link to the advertisement to a plurality of advertisement recipients, and provides a prompt list of receiving organizations to which advertisement recipients can direct gift values. The advertiser receives an input regarding at least one receiving organization designated to receive a portion of the gift value amount. In some embodiments, the method also includes prompting gift recipients to add to the initial gift value. In some embodiments, the link provided to advertisement recipients includes sending the link using a social media account. More specifically, in some embodiments, an advertiser's social media account is used to send the link to advertisement recipients. The method also includes the selection of at least one metric to measure the effectiveness of a particular advertising campaign. The method, in one embodiment, includes measuring the at least one metric for an amount of time and comparing that to money spent in creating the advertisement the gift provisioning system. Any metric can be used including overall sales, sales per customer.

Also disclosed is a gift provisioning system for creating advertisements includes a computing machine further including a processor and a memory associated with the processor, and a display having a graphical user interface. The display is communicatively coupled to the processor and memory. The computing machine also includes an advertising creation module including instructions that, when executed by the processor, causes the computing machine to create an advertising campaign. The instructions and processor create an advertisement in a gift provisioning system, provide a link to the advertisement in the gift provisioning system, allocate an initial gift value amount to be associated with the advertisement, and send a link to the advertisement to a plurality of advertisement recipients. The instructions and processor present a prompt at the display that lists receiving organizations to which advertisement recipients can direct or delegate gift values. The processor and instructions also receive an input that designates at least one

It is to be understood that even though numerous characteristics and advantages of various embodiments of the present invention have been set forth in the foregoing description, together with details of the structure and function of various embodiments of the invention, this disclosure is illustrative only, and changes may be made in detail, especially in matters of structure and arrangement of parts within the principles of the present invention to the full extent indicated by the broad general meaning of the terms in which the appended claims are expressed. For example, the particular physical components, software development tools and code and infrastructure management software may vary depending on the particular system design, while maintaining substantially the same features and functionality and without departing from the scope and spirit of the present invention.

1. A method comprising:
creating an advertisement in a gift provisioning system;
providing a link to the advertisement in the gift provisioning system;
allocating an initial gift value amount to be associated with the advertisement;
sending a link to the advertisement to a plurality of advertisement recipients;
providing a prompt list of receiving organizations to which advertisement recipients can direct gift values; and
receiving an input regarding designating at least one receiving organization to direct a portion of the gift value amount.

2. The method of claim 1 further comprising prompting gift recipients to add to the initial gift value.

3. The method of claim 1 wherein sending the link to advertisement recipients includes sending the link using a social media account.

4. The method of claim 3 wherein sending the link to advertisement recipients includes sending the link using an advertiser's social media account.

5. The method of claim 1 further comprising selecting at least one metric to measure the effectiveness of a particular advertising campaign.

6. The method of claim 5 further comprising measuring the at least one metric for an amount of time and comparing that to money spent in creating the advertisement the gift provisioning system.

7. The method of claim 5 wherein the metric measured is overall sales.

8. The method of claim 5 wherein the metric measured is sales per customer.

9. A gift provisioning system for creating advertisements comprising:
a computing machine further comprising:
a processor;
a memory associated with the processor;
a display having a graphical user interface, the display communicatively coupled to the processor and memory; and
an advertising creation module including instructions that, when executed by the processor, causes the computing machine to create an advertising campaign, the instructions and processor:
creating an advertisement in a gift provisioning system;
providing a link to the advertisement in the gift provisioning system;
allocating an initial gift value amount to be associated with the advertisement;
sending a link to the advertisement to a plurality of advertisement recipients;
presenting a prompt listing receiving organizations to which advertisement recipients can direct gift values; and
receiving an input that designates at least one receiving organization to direct a portion of the gift value amount.

10. The gift provisioning system of claim 9 where the instructions of the advertising creation module further comprise prompting gift recipients to add to the initial gift value.

11. The gift provisioning system of claim 9 wherein sending the link to advertisement recipients includes sending the link using a social media account.

12. The gift provisioning system of claim 9 wherein sending the link to advertisement recipients includes sending the link using an advertiser's social media account.

13. The gift provisioning system of claim 9 where the instructions of the advertising creation module further comprise a prompt for selecting at least one metric to measure the effectiveness of a particular advertising campaign.

14. The gift provisioning system of claim 13 where the instructions of the advertising creation module further comprise a measuring the at least one metric for an amount of time and comparing that to money spent in creating the advertisement the gift provisioning system.

15. The gift provisioning system of claim 13 wherein the metric measured is overall sales.

16. The gift provisioning system of claim 13 wherein the metric measured is sales per customer.

17. An advertisement creating and gift provisioning system comprising:
a processor;
a memory communicatively coupled with the processor;
a display having a graphical user interface, the display communicatively coupled to the processor and memory; and
an advertising creation module communicatively coupled to the processor and the memory, the advertising creation module including:
a link providing module for providing a link to the advertisement in the gift provisioning system;
an initial gift value allocation module for allocating an amount to be associated with the advertisement;
a sending module for sending a link to the advertisement to a plurality of advertisement recipients;
a prompt module for providing a prompt list of receiving organizations to which advertisement recipients can direct gift values; and
an input receiving module for receiving an input regarding designating at least one receiving organization to direct a portion of the gift value amount.
